(19) United States
(12) Patent Application Publication
(10) Pub. No.: US 2012/0222871 A1
(43) Pub. Date: Sep. 6, 2012

(54) HORSE SHOE WITH SPLAYING FEATURE AND FLEXIBILITY

(76) Inventor: Murali Mahidhara, Pittsburgh, PA (US)

(21) Appl. No.: 13/261,128

(22) PCT Filed: Dec. 31, 2010
(86) PCT No.: PCT/US2010/003264

§ 371 Date: Jan. 9, 2012

(51) Int. Cl. A01L 1/00; A01L 5/00

(52) U.S. Cl. 168/6

(57) ABSTRACT

A horseshoe with splaying and flexibility features has a U shaped compliant metallic unitary body having left and right wings and a central toe area integral with the body, and a compliant leaf-spring formation disposed proximate to or as part of the toe area. The leaf spring is arch shaped and resiliently deforms and exerts horizontal pressure sideways on the left and right wings thus splaying the left and right wings. The arch shape forms a cavity which is optionally filled with a resilient material, e.g., polyurethane, to prevent accumulation of debris in the cavity. Contiguous serrations on the left and right wings provide relative vertical flexibility of the left and right wings. The splaying and flexibility enhance horse-hoof comfort and hoof-structure re-generation. The horseshoe may be cast/forged, blanked, or welded or produced by mechanical joining. Hardened stainless steel or Titanium, or other material may be used for the horseshoe.

### FIELD OF THE INVENTION

The present invention is directed to a horseshoe, and more particularly to a horseshoe which is relatively inexpensive and provides a splaying feature as well as flexibility, to promote hoof-comfort and hoof structure regeneration for the horse.

### BACKGROUND OF THE INVENTION

It has been the object of many horseshoe designers and farriers to provide a horseshoe which is hoof-friendly and which mimics to some extent the movement of a horse's hoof when the horse is walking or running, especially on a hard surface. Various attempts have been made over decades to obviate the rigidity of conventional metallic horseshoes by introducing nonmetallic elements that provide selected degrees of flexibility and resilience.

Prior art includes examples of horseshoe designs incorporating shock absorbing materials (such as for example in U.S. Pat. No. 5,348,098,) either in layers with metallic components or otherwise, without any provision for splaying. There are also examples of flexible horseshoe design in prior art, without any provision for splaying. U.S. Pat. Nos. 6,076,607, 4,513,824, 4,333,532, and 3,628,608 are examples of flexible horseshoes. U.S. Pat. No. 6,810,962 describes a composite horseshoe with a resilient intermediate layer to fill out interspaces between rigid upper and lower parts.

There are also specialty type horseshoe designs in prior art to address specific design needs but not splaying. For example, U.S. Pat. No. 5,727,633 to Ovnicek describes a horseshoe designed for lame horses and has a closed end toe section provided with a concave depression sufficient to avoid contact with the sole of a horse's foot beneath the tip of the coffin bone. The Ovnicek patent describes essentially a “combination” of hoof pad (which is preferably wedge-shaped) with a frog insert and a horseshoe element which raises the horse's heel, to assist a lame horse. It also seems essential in the Ovnicek patent that in order for the “combination” to be effective, the elevated heels and the frog insert must be elongated (vide column 2 of the Ovnicek patent). Notably, the Ovnicek patent provides for no flexibility between left and right wings of the horseshoe, and no such flexibility seems envisaged therein.

U.S. Pat. No. 6,076,607 (Bergeleen) describes a composite horseshoe having left and right body portions and a selectable detachable and interchangeable centerpiece in the toe region, enabling the flexibility of the shoe to be adjusted as desired. The selected centerpiece is provided with tapped holes extending horizontally one on each side and is assembled and held in place by screws inserted in the left and right body portions. The horseshoe in this prior art patent is described as being provided with antisplay flanges which however need to be assembled, thus increasing the cost of using this type of prior art horseshoe.

U.S. Pat. No. 6,082,462 (to Lyden) describes a composite horseshoe which is made of flexible and relatively inflexible materials and which can include a resilient pad for attenuating shock and vibration. U.S. Pat. No. 6,443,232 describes a horseshoe having shock-absorbing qualities, the shoe having a resilient polymer that is sandwiched between metal plates. Yet another horseshoe described as having adherence and a grip over any kind of ground is seen in U.S. Pat. No. 5,988,288 (to Bourdieu), wherein, a rigid core piece may be partially coated with or encased in a rubber compound.

US Patent-publication 2005/0034877 A1 to Bergeleen, dated Feb. 17, 2005 provides a horseshoe that comprises a body made of a molded, flexible polyolefin plastic such as molded ultrahigh molecular weight polyethylene (UHMWPE) or polypropylene, the body having a separate spring metal insert shaped similar to the horseshoe body, enabling the shoe to expand. The horseshoe in the foregoing preliminary publication 2005/0034877 A1 includes a molded-in perforated screen or mesh of steel, aluminum or other metal embedded in the horseshoe-body to add rigidity to the shoe and to constrain the shoe to movement in one plane. The spring metal insert in this prior art composite design is described as sufficiently strong as to pull the UHMWPE body back into its original configuration when weight on the hoof is relieved.

U.S. Pat. No. 6,497,293 B1 to Miller teaches a composite horseshoe with a sole made of resilient material (such as polyurethane, natural rubber, synthetic rubber or a combination thereof) and including a toe insert, two heel areas and two tapered hinges each connecting the toe insert and one of the heel areas. The tapered hinges are described as being made of the same material as the sole and are said to allow expansion and relaxation of the horseshoe to assist a horse in motion.

It has however been found that the prior art horseshoe designs which provide resilience are composite, or use several parts and components, and do not offer simplicity, reliability or cost effectiveness. Those prior art horseshoes which by design use predominantly resilient material are invariably generally less durable (-short life-) than the conventional rigid metallic designs which might however restrict expansion and thus cause increased stress in the hoof and legs of the horse, particularly during racing

Despite the availability of horseshoe designs providing shock absorption, flexibility and such features, there is still a need for a horseshoe design which is characterized by simplicity, economy and including controlled splaying without any need for a multiplicity of components and without the need for assembly of parts. The present invention intends to obviate certain less desirable aspects of prior art horseshoe design and provides a relatively less expensive and very simple design which aims at providing the much desired splaying for mitigating hoof-stress particularly during racing. The present invention also aims at providing structural features in the horseshoe to promote hoof-comfort and consequent hoof-wall-growth and hoof structure regeneration.

### SUMMARY OF THE INVENTION

The present invention provides a simple and economical horseshoe design, unitary in construction and preferably of metallic material, which permits splaying and flexibility, thus permitting natural hoof expansion in use, for the horse, enabling improved blood circulation in the hoof area and reducing hoof-stress which is otherwise caused in prior art conventional-type rigid horseshoes. Additionally, the present invention provides a horseshoe which is intended to promote hoof-comfort and consequent hoof-wall-growth and hoof structure regeneration.

A first embodiment of the invention in its broad form resides in a horseshoe capable of accommodating splaying of a horse hoof in use, said horseshoe having a generally U shaped unitary metallic body including a heel-region and including left and right body portions having undersurfaces lying on a common bottom plane of the horseshoe, and a central toe area connected to the left and right body portions in a location away from the heel-region, the central toe area acting like a spring element and being generally of a crescent shape including a convex outer edge and a concave inner edge, the convex outer edge being substantially in said common bottom plane, the concave inner edge projecting below said common bottom plane by a chosen designed dimension, whereby when said central toe area of the horseshoe in use impacts ground, the central toe area acts like a spring element whereby the concave inner edge of the central toe area flattens by being resiliently pushed up, thereby allowing the left and right body portions of the horseshoe to splay, whereby when the central toe area is not impacting the ground, the left and right body portions of the horseshoe are restored to their original positions without splay. Optionally, the left and right wings, on their undersurface may have serrations or similar formations to facilitate flexing of said left and right wings in a direction substantially at right angles to the common bottom plane, whereby hoof-comfort can be enhanced. Preferably, the horseshoe of the present invention is non-composite in construction.

A second embodiment resides in a generally U shaped compliant metallic horseshoe having left and right wings and a central toe area integral with the left and right wings and including an open recess facing the left and right wings in a substantially horizontal plane, the horseshoe including a compliant leaf-spring portion disposed proximate to the central toe area and integrally bridging the left and right wings, the leaf-spring having a first unstressed state and a second stressed state, the leaf-spring in its unstressed state having an arch shape projecting downwards of the left and right wings and below said horizontal plane, the leaf-spring attaining its said second stressed state upon loading of the horseshoe in use by ground-impact to cause the arch shape to resiliently deform vertically upwards and thus exert horizontal pressure sideways on the left and right wings so as to splay apart the left and right wings by a desired predetermined dimension, the leaf-spring portion being restored to its first unstressed state when the horseshoe in use is not loaded or not impacting ground, when the left and right wings are restored to their positions without splay. Optionally, the left and right wings, on their undersurface may have serrations to facilitate enhancing ground-grip and to assist flexing of the left and right wings in a direction substantially at right angles to the horizontal plane, whereby hoof-comfort can be enhanced.

A third embodiment in its broad form resides in a metallic horseshoe capable of accommodating splaying of the horse hoof in use, the horseshoe having a generally U shaped unitary body and including left and right body portions lying on a bottom plane of the horseshoe, the left and right body portions adjacent the bottom plane including serrations permitting flexing of the left and right body portions in a direction substantially perpendicular to the bottom plane, the U shaped unitary body including a central toe portion bridging the left and right body portions, the left and right body portions being capable of being splayed in directions parallel to said bottom plane, the central toe portion being configured to function as a leaf-spring and having a first unstressed state and a second stressed state, the central toe portion in its unstressed state having a substantially central convex formation projecting below the identified bottom plane, the central toe portion attaining its stressed state by loading of the horseshoe caused when the horse shoe in use impacts ground, the central convex formation of the leaf spring tending to be flattened in its second stressed state thereby enabling the left and right body portions of the horseshoe to splay apart by a predetermined dimension, whereby the central toe portion alternately and successively goes through its second stressed state and its first state respectively when the horse hoof in use impacts/touches ground and is off ground.

### BRIEF DESCRIPTION OF THE DRAWING

A more detailed understanding of the invention may be had from the following description of preferred embodiments which are exemplary and not intended to be limiting, and to be understood in conjunction with the accompanying drawings wherein:

FIG. 1 illustrates a first embodiment of the invention;

FIG. 2 illustrates a second embodiment of the invention;

FIG. 3 illustrates a pictorial view of the first embodiment of the present horseshoe; and,

FIG. 4 illustrates views of a third embodiment of the inventive horseshoe which is provided with features offering splaying, and additionally including serrations which allow flexibility of left and right portions of the horseshoe in a vertical plane as needed.

### DETAILED DESCRIPTION OF EMBODIMENTS

A detailed description of one or more embodiments of the invention is provided below in the context of the accompanying figures that illustrate by way of example the principles of the invention. While the invention is described in connection with such embodiments, it should be understood that the invention is not limited to any particular embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention

The present invention may be practiced according to the claims without some or all of these specific details. For the purpose of clarity, technical material that is known in the technical fields related to the invention has not been described in detail so that the present invention is not unnecessarily obscured.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made. The embodiments included herein are described in sufficient detail to enable those skilled in the art to practice the invention, and it is to be understood that other embodiments may be utilized including changes that may be made without departing from the scope of the present invention. The description herein is by way of example only, and is therefore not to be taken in a limiting sense, and the scope of the present invention is defined only by the appended claims and their equivalents.

Described hereinafter are embodiments of a unitary non-composite horseshoe which is preferably metallic and having a configuration intended to promote hoof-comfort and consequent hoof-wall-growth and hoof structure regeneration

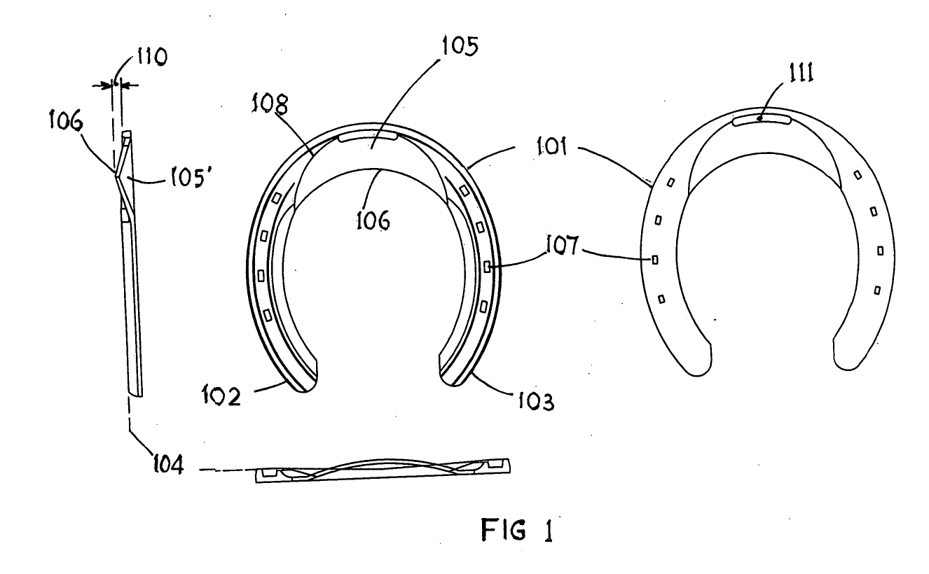

FIG. 1 generally shows an exemplary diagrammatic illustration of the first embodiment of the inventive horseshoe. As shown, the horseshoe includes a generally U shaped body 101 including left and right body portions 102, 103 which have an undersurface lying on a common bottom plane 104. The left and right body portions 102 and 103 are bridged by a crescent shaped toe area 105 functioning like a leaf spring, which includes a concave inner edge 106 and a convex outer edge 108. The concave inner edge 106 includes portions substantially projecting below the common bottom plane 104 by a chosen design dimension 110. When the horseshoe is loaded (such as when the horse is standing or when the hoof impact the ground during running) the central convex formation of the leaf spring in the toe area 105 gets into its loaded state or stressed state when the leaf spring portion of the toe area 105 tends to be resiliently flattened thereby enabling the left and right body portions to resiliently splay by a predetermined amount. In the unstressed state of the toe area 105, the splay is absent or is reversed. Thus, the central toe area in 105 alternately and successively goes through its stressed and unstressed states when the horse hoof touches/impacts ground and is off ground respectively. It is further noted that the central convex formation creates a space or cavity between the leaf spring portion explained above, and the underside of the horse hoof in use. Expediently, the space or cavity may be filled with a compressible (resilient) material filler 105′ e.g., polyurethane or a suitable grade of compressible resin which when retained in place can prevent accumulation of pebbles/dirt or other hard material which might impede the leaf spring from functioning as intended, and also cause discomfort to the hoof. Other suitable fillers in lieu of the polyurethane material are within the purview of the present invention. The polyurethane material/resin may be placed in the space/cavity either at the time the horse shoe is manufactured or by the farriers after the horseshoe is installed on the horse hoof. It is envisaged that the resilience of the polyurethane foam material will not impede flattening of the leaf spring as explained above, but permit splaying of the left and right body portions of the horse shoe. The inventive horseshoe is fastened/installed into position on the hoof by nails placed in the nail holes 107. Other fasteners in lieu of nails may be used instead as intelligible to those skilled in the art.

Optionally, the first embodiment may have the following features:

The concave inner edge in the first embodiment may have its ends substantially in level with the common bottom plane and wherein the chosen design dimension occurs at substantially a center region of the concave inner edge. The chosen designed dimension may be determined by a desired magnitude of splay of the left and right body portions. The central toe area of the horseshoe may be integral with the left and right body portions, or may be joined to the left and right body portions by welding, brazing, or mechanical joining. Alternatively, the entire horseshoe may be obtained by forging or casting, or a combination of casting and forging, or by welding.

The horseshoe might comprise ferrous material such as for example hardened stainless steel 17-4 PH or any other suitable grade, or nonferrous material such as for example, Titanium, or a suitable Aluminum alloy. The central toe area of the horseshoe may be obtained by a separate forging operation. Alternatively, the central toe area, and left and right body portions may all be cast together (with optional forging followed) from material comprising Titanium, or Aluminum alloy or any desired grade of stainless steel, e.g., hardened stainless steel 17-4 PH.

As a variation, the central toe area of the horseshoe might include an elongated recess 111 adjacent the convex outer edge. Preferably, the central toe area is devoid of nail-holes 107 which may be generally limited to the left and right body portions of the horseshoe.

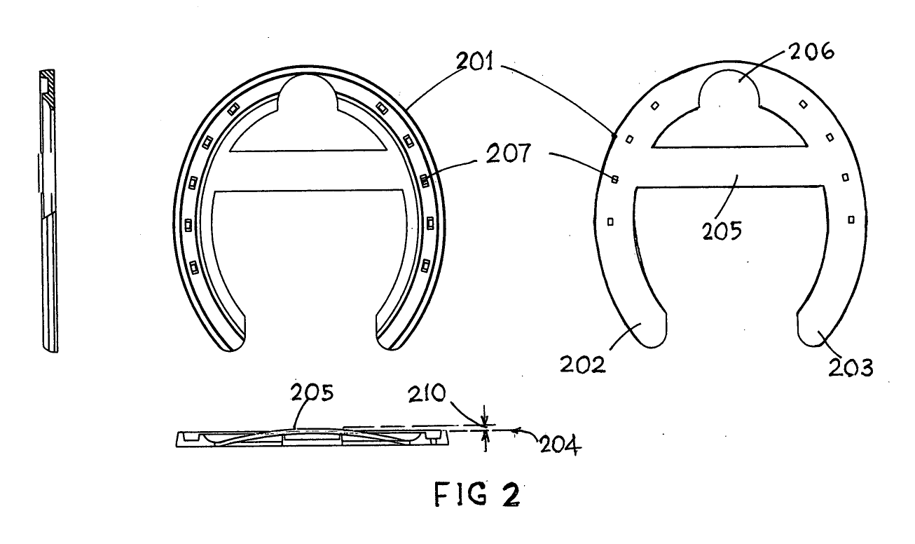

In a second embodiment, the invention provides a generally U shaped compliant horseshoe having left and right wings and a central toe area integral with the left and right wings and including an optional open recess facing the left and right wings, the horseshoe including a compliant leaf-spring disposed proximate to the central toe area, but not at the central toe area, and attachedly bridging said left and right wings. An example of the second embodiment may be seen in FIG. 2. As shown, this embodiment includes a generally U shaped body 201, including left and right wings 202 and 203 lying on a common undersurface 204. A compliant leaf-spring 205 preferably integral with the body 201 bridges the left and right wings and bows in its normal unstressed state below the state below the undersurface 204 by a chosen design dimension 210. Advantageously, the leaf spring is disposed proximate the central toe area where an open recess 206 is located. The leaf-spring has a first (normal) unstressed state and a second stressed state, the leaf-spring attaining its second stressed state upon loading/impacting of the horseshoe in use by ground-contact. In its second stressed state, the leaf-spring is resiliently deformed vertically upwards of the undersurface 204, thus exerting horizontal pressure sideways on the left and right wings so as to splay the left and right wings by a desired predetermined dimension. The leaf-spring is restored to its first unstressed state reversing or undoing the splay when the horseshoe in use is not loaded or is not touching ground in use. Thus, each time the horseshoe impacts the ground, or each time when the horseshoe is loaded by the horse simply putting its weight on the horseshoe, the leaf-spring gets into its second stressed state and causes the left and right wings 202 and 203 to splay resiliently. During moments when the horseshoe is not loaded, such as when the hoof is up in the air momentarily during the running motion of the horse, the splay is undone. In all the embodiments described herein, the cyclic splay and the lack of splay conform to the natural hoof-loading, thus enhancing hoof-comfort. The provision of the open recess 206 assists the splay-response of the left and right wings 202 and 203. Nail holes 207 enable fastening of the horseshoe to the hoof. Alternative methods of fastening the horseshoe to the hoof are acceptable, and will be intelligible to those skilled in the art.

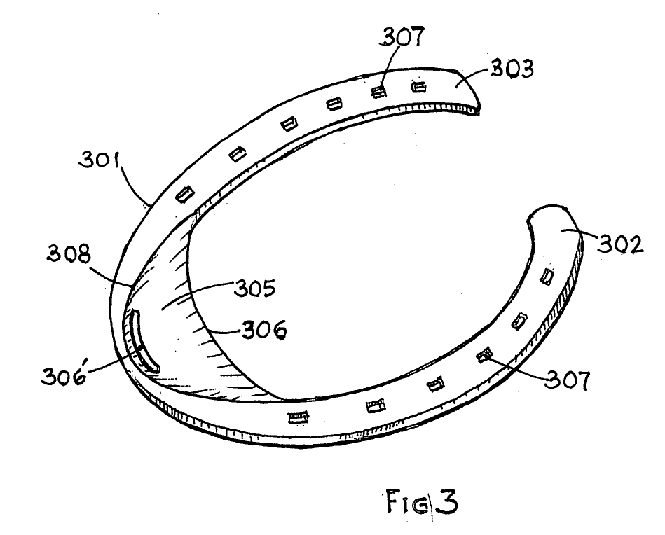

In another preferred form shown in FIG. 3, the invention provides a horseshoe capable of accommodating splaying of a horse hoof in use, the horseshoe having a generally U shaped body 301 including a heel-region and including left and right body portions 302, 303, having undersurfaces lying on a common bottom plane (-not shown-) of the horseshoe, and a central toe area 305 connected to the left and right body portions 302, 303 of the U shaped body 301 in a location away from the heel-region, the central toe area 305 acting like a spring element and being generally of a crescent shape including a convex outer edge and a concave inner edge. The central toe area 305 has a convex edge 308 and a concave inner edge 306 and an optional arcuate aperture 306′ and an optional slit in the front of the central toe area. The illustration in FIG. 3 shows the arcuate aperture 306′, but not the slit. The slit preferably extends from the inside of the aperture 306′ to the front of the central toe area. The convex outer edge 308 of the central toe area 305 is substantially in said common bottom plane, and the concave inner edge 306 projects below the common bottom plane by a chosen designed dimension (similar to the dimension 110 in FIG. 1), whereby when the central toe area of the horseshoe in use impacts ground, the central toe area acts like a spring element causing spring action. The concave inner edge 306 of the central toe area 305 flattens because of the spring action by being resiliently pushed up when the toe area of the horseshoe hits or impacts the ground thereby allowing the left and right body portions to resiliently splay. It is noted that when the central toe area is not impacting/touching the ground, the left and right body portions are restored to their original positions without splay. The splaying action could be transient when the horse is racing, but the splaying may not be transient when the horse is standing in its stall. The hoof loading/impact is taken into account in deciding the chosen designed dimension by which the concave inner edge projects below the common bottom plane. The chosen designed dimension influences the degree of the spring action which in turn controls the degree of splaying. The splaying action as described herein is necessary and desirable to alleviate stresses caused by the hoof-impact with the ground when the horse is racing. The degree of impact may be assessed by the designer by taking into account the parameters including the horse's hoof size, the horse's weight range, envisaged maximum ground speed, the hardness of ground and the modulus of elasticity of the horseshoe material to ascertain the maximum extent of splaying which can be obtained. Those skilled in the art are aware that when a race horse runs on a race-track at 30-40 miles an hour, the entire hoof-impact duration can be of the order of milliseconds, and it is thus desirable to deliberately permit a predetermined degree of splaying of the left and right body portions of the horseshoe during the hoof-impact duration. The present invention aims at accomplishing achieving the splaying without complicated gadgetry in the horseshoe or without the use of any composite materials constituting the horseshoe. The present design thus permits splaying of the left and right body portions of the horseshoe by resorting to a simple, reliable and cost effective design of the horse shoe

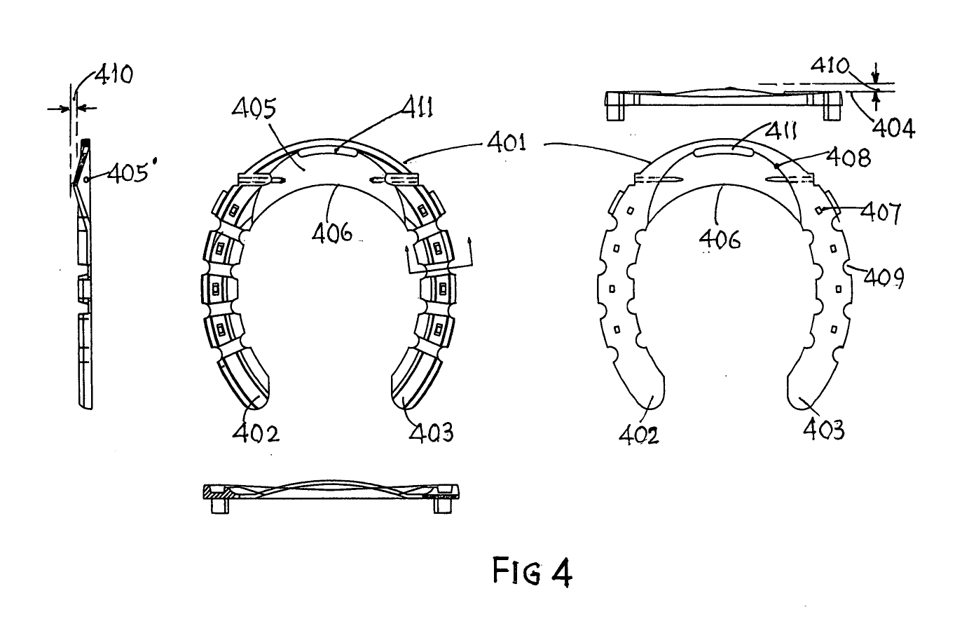

Another horseshoe embodiment illustrated in FIG. 4 by way of example includes serrations that enable relative flexibility between the right and left wings whereby in a flexed state of the horseshoe, the right and left wings thereof may not be co-planar. Again, this kind of flexibility provided for in this embodiment has been found in to be desirable in promoting hoof comfort and hoof-structure-regeneration. The horseshoe illustrated in FIG. 4, includes a generally U shaped unitary body 401 having left and right body portions 402 and 403 lying at rest on a common bottom plane 404, and bridged by a toe area 405. The serrations may have a configuration as shown at 409 and may be selectively provided on the convex and concave sides of the left and right wings, as well as the undersurface of the horseshoe. The serrations provided on the undersurface of the horseshoe serve to enhance the ground-grip for a horse which is affixed with the inventive horseshoe. The serrations 409 may be provided contiguously, starting from said central toe area and proceeding towards open ends of said U shaped body. The serrations typically may be so dimensioned as to reduce the rigidity level of the left and right wings to allow flexibility. Desirably, the flexible horseshoe of the invention might include the leaf-spring, the serrations and the polyurethane/resin filler, so as to combine all the inventive features in one embodiment. Other alternative structural features in lieu of the serrations to provide flexibility between the left and right wings are also within the ambit of the present invention. For example, notches may take the place of the serrations. The horse shoe may be secured in place for deployment, using nails in the nail-holes 407. Upon ground impact or when the horseshoe is loaded, the toe area 405 resiliently deforms to the extent permitted by the dimension 410, to exert pressure sideways on the left and right (wings) body portions 402, 403 to splay them apart resiliently. As in the embodiment of FIG. 1, the toe area 405 of the configuration of the horseshoe illustrated in FIG. 4 includes a concave inner edge 406 and a convex outer edge 408. The inner edge 406 projects below the undersurface 404 by a chosen design dimension 410. Optionally, the toe area may include a slot 411.

The toe area 405 shown in FIG. 4 forms a cavity in use which may be filled with a resilient compressible material 405′ such as the polyurethane or compressible resin which assists in preventing accumulation of pebbles, dirt, debris and other such material from compacting inside the cavity or space referred to above. Compaction of extraneous material such as pebbles inside the space or cavity is inconducive to the functioning of the leaf spring as intended, and might impede the splaying of the left and right wings of the horseshoe. Other compressible inert materials for fillers in lieu of Polyurethane or resin are also acceptable.

With or without the serrations, the toe area (405) leaf-spring along with the polyurethane filler in use functions in such a manner that the resilient deformation of the leaf-spring causes the left and right wings of the horseshoe to splay by a predetermined amount. As aforesaid, the splaying provision enhances hoof comfort and hoof regeneration.

In any of the above embodiments, the generally U shaped body of the horseshoe could comprise a single piece which is obtained by any process chosen from forging, casting, blanking, welding, brazing or a combination of casting and forging. Other methods of obtaining the U shaped body are within the purview of the invention. The horseshoe might comprise a U shaped body obtained by a forging operation using precipitation hardened stainless steel 17-4 PH. Alternatively, the U shaped body may be obtained from Titanium.

In one embodiment, serrations/notches are provided on an undersurface of the left and right body portions. In a preferred variation, serrations are provided on arcuate sides of said left and right body portions as well as on an undersurface of said left and right body portions

Advantageously, the central toe portion of the horseshoe may include an arcuate configuration (with a convex outer edge and a concave inner edge) formed contiguously with the left and right body portions/wings, the central convex formation being located along said concave inner edge. In a preferred embodiment, the central toe portion includes an arcuate elongated aperture substantially in a middle portion of the convex outer edge.

For affixing the horseshoe to the horse hoof, the left and right body portions include a plurality of nail-holes for driving nails in a direction substantially perpendicular to the bottom plane, and the central toe portion may include a provision for inserting nails in a direction parallel to the bottom plane. It is also noted that the convex outer edge projects below said bottom plane by a chosen design dimension, taking into account material properties of the horseshoe metal and an average value of envisaged hoof loading.

In all the embodiments and their modifications in the present inventions, the material for the horseshoe might comprise suitable metallic material chosen from Titanium, Aluminum alloy, or ferrous material such as a suitable grade of steel, or stainless steel e.g., hardened stainless steel 17-4 PH.

Preferred embodiments described above selectively offer one or more of the following advantages:

1. The preferred embodiment of the inventive horseshoe as described is of unitary construction and requires no assembly, and accordingly eliminates additional assembly costs.
2. The preferred embodiment being of unitary-construction, may be mass produced by forging, casting, blanking or a combination thereof, the mass production serving to lower the manufacturing costs.
3. The inventive horseshoe is metallic, and lasts at least as long as other prior art metallic horseshoes.
4. The inventive horseshoes when offered in precipitation hardened stainless steel 17-4 PH are rustproof and more desirable than prior art metallic ferrous based horseshoes.
5. The splaying action provided in all the embodiments provides significant hoof-comfort and improved blood circulation in the hoof area, thereby promoting hoof-regeneration.
6. The serrations provided selectively on the undersurface of the horseshoe serve to enhance the ground-grip for the horseshoe in use.
7. The serrations provided in the side regions of the left and right wings, as well the undersurface of the left and right wings are conducive to create flexing of the horseshoe in a vertical direction at right angles to the undersurface, thus enhancing hoof comfort.

In the foregoing detailed description of embodiments of the invention, various features may have been grouped together in a single exemplary embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled. In the appended claims, the terms “including” and “in which” where present, are used as the plain-English equivalents of the respective terms “comprising” and “wherein,” respectively. Moreover, the terms “first,” “second,” and “third,” etc., if used, are used merely as labels, and are not intended to impose numerical requirements on their objects.

1. A horseshoe capable of accommodating splaying of a horse hoof in use, said horseshoe having a generally U shaped unitary body including a heel-region and including left and right body portions having undersurfaces lying on a common bottom plane of the horseshoe, and a central toe area connected to said left and right body portions in a location away from said heel-region, said central toe area acting like a spring element and being generally of a crescent shape including a convex outer edge and a concave inner edge, said convex outer edge being substantially in said common bottom plane, said concave inner edge in use projecting below said common bottom plane by a chosen designed dimension, whereby when said central toe area of the horseshoe in use impacts ground, said central toe area acts like a spring element and said concave inner edge of the central toe area flattens by being resiliently pushed up thereby causing and allowing said left and right body portions of the horseshoe to splay, whereby when said central toe area is not impacting the ground, said left and right body portions of the horseshoe are restored to their original positions without splay.

2. The horseshoe as in claim 1, wherein said concave inner edge has its ends substantially in level with said common bottom plane and wherein said chosen design dimension occurs at substantially a central region of said concave inner edge.

3. The horseshoe as in claim 2, wherein said chosen designed dimension is determined by a desired magnitude of splay of said left and right body portions, and wherein said crescent shape of said toe area while the horseshoe is in use, forms a cavity which is filled with a resilient compressible material.

4. The horseshoe as in claim 2 wherein said central toe area is integral with said left and right body portions, and wherein said left and right body portions selectively include serrations to allow relative flexibility between said left and right body portions.

5. The horseshoe as in claim 2 wherein said central toe area is obtained by an operation chosen from forging, casting, welding, brazing, a combination of casting and forging, and mechanical joining.

6. The horseshoe as in claim 3 wherein said central toe area, and left and right body portions are all integral, and said resilient compressible material comprises polyurethane.

7. The horseshoe as in claim 6 wherein the horseshoe is made of hardened stainless steel 17-4 PH.

8. The horseshoe as in claim 6 wherein the horseshoe comprises material chosen from cast/forged Aluminum alloy and Titanium.

9. The horseshoe as in claim 4 wherein said serrations are provided contiguously, starting from said central toe area and proceeding towards open ends of said U shaped body, and wherein said central area includes an elongated recess adjacent said convex outer edge, and wherein the horseshoe comprises stainless steel.

10. A generally U shaped compliant horseshoe having left and right wings and a central toe area integral with said left and right wings and including an open recess facing said left and right wings in a substantially horizontal plane, the horseshoe including a compliant leaf-spring disposed proximate to said central toe area and attachedly bridging said left and right wings, said leaf-spring having a first unstressed state and a second stressed state, said leaf-spring in its unstressed state having an arch shape projecting downwards of said left and right wings and below said horizontal plane, said leaf-spring attaining its said second stressed state upon loading of the horseshoe in use by ground impact to cause said arch shape to resiliently deform vertically upwards and thus exert horizontal pressure sideways on said left and right wings so as to splay said left and right wings by a desired predetermined dimension, said leaf-spring being restored to its first unstressed state when the horseshoe in use is not loaded or not impacting ground, when said left and right wings are restored to their positions without splay.

11. A horseshoe capable of accommodating splaying of a horse hoof in use, said horseshoe having a generally U shaped unitary body and including left and right body portions lying on a bottom plane of the horseshoe, and a central toe portion bridging said left and right body portions, said left and right body portions being capable of being splayed, said central toe portion being configured to function as a leaf-spring and having a first unstressed state and a second stressed state, said central toe portion in its said unstressed state having a substantially central convex formation in use projecting below said bottom plane, said central toe portion attaining its said second stressed state by loading of the horseshoe caused when the horse shoe in use impacts ground, said central convex formation of the leaf spring tending to be flattened in its said second stressed state thereby causing and enabling said left and right body portions to splay by a predetermined dimension, whereby said central toe portion continually and alternately goes through its said second stressed and said first unstressed states respectively when the horse hoof in use impacts ground and is off ground, said left and right portions of the horseshoe further selectively including serrations to allow relative flexibility between said left and right body portions in a direction substantially perpendicular to said bottom plane.

12. The horseshoe as in claim 11 wherein said generally U shaped body comprises a single piece which is obtained by any one process chosen from forging, casting, a combination of casting ad forging, blanking, welding or brazing.

13. The horseshoe as in claim 11 wherein said generally U shaped body is obtained by a forging operation using precipitation hardened stainless steel 17-4 PH.

14. The horseshoe as in claim 11 wherein said generally U shaped body is obtained from Titanium.

15. The horseshoe as in claim 11, wherein said serrations are provided on an undersurface of said left and right body portions in said bottom plane.

16. The horseshoe as in claim 11, wherein said serrations are provided on arcuate sides of said left and right body portions as well as on an undersurface of said left and right body portions.

17. The horseshoe as in claim 11, wherein said central toe portion includes an arcuate configuration with a convex outer edge and a concave inner edge, said central convex formation being located along said concave inner edge.

18. The horseshoe as in claim 17, wherein said central toe portion includes an arcuate elongated aperture substantially in a middle portion of said convex outer edge.

19. The horseshoe as in claim 18, wherein said left and right body portions include a plurality of nail-holes for driving nails in a direction substantially perpendicular to said bottom plane, and wherein said central toe portion includes a provision for inserting nails in a direction parallel to said bottom plane.

20. The horseshoe as in claim 17, wherein said convex outer edge projects below said bottom plane by a chosen design dimension, taking into account material properties of the horseshoe and an average envisaged hoof loading.
